(19) United States
(12) Patent Application Publication
(10) Pub. No.: US 2014/0267077 A1
(43) Pub. Date: Sep. 18, 2014

(54) User Device with a Primary Display and a Substantially Transparent Secondary Display

(71) Applicant: AMAZON TECHNOLOGIES, INC., (US)

(72) Inventor: Fareed Adib Qaddoura, Bellevue, WA (US)

(73) Assignee: AMAZON TECHNOLOGIES, INC., Reno, NV (US)

(21) Appl. No.: 13/835,916

(22) Filed: Mar. 15, 2013

(51) Int. Cl. G06F 3/041

(52) U.S. Cl. CPC G06F 3/041
USPC 345/173

(57) ABSTRACT

This disclosure relates to systems and methods for projecting an image from a primary display onto a secondary display and enabling the user to interact with the user device by touching the secondary display. The secondary display may be positioned to intercept the light emitted from the primary display. The secondary display may be a transparent or semi-transparent component that reflects or refracts the image on the primary display.

### BACKGROUND

User devices have become ubiquitous at home and at work. The user devices may include a display that displays content to a user, and the display may also receive inputs from the user. User devices also may be used to interact with other nearby electronic devices or non-electronic elements (e.g., bar codes). The user devices may be oriented to interact or interface with the electronic devices or non-electronic elements in a way that places the display out of the line of sight of the user. The user may have to re-orient the device to view the display to confirm the interaction was completed successfully. Hence, users may want to minimize the time and effort to confirm a successful interaction has taken place.

### BRIEF DESCRIPTION OF THE DRAWINGS

FIG. 1 illustrates a perspective view of a system that uses a primary display to project an image onto a secondary display to provide another viewing angle for the content in accordance with one or more embodiments of the disclosure.

FIG. 2 illustrates a top view, a side view, and a front view of a system that uses a primary display to project an image onto a secondary display to provide another viewing angle for the content in accordance with one or more embodiments of the disclosure.

FIG. 3 illustrates an exemplary embodiment of mapping the location of images on the primary display to images or locations on the secondary display in accordance with one or more embodiments of the disclosure.

FIG. 4 illustrates a side view and a front view of another embodiment of the system that segregates a primary display from a secondary display in accordance with one or more embodiments of the disclosure.

FIG. 5 illustrates a flow diagram of a method for projecting content from a primary display onto a secondary display so that a user may view the content when the user is not in the line of sight of the primary display in accordance with one or more embodiments of the disclosure.

FIG. 6 illustrates a flow diagram of another method for projecting content from a primary display onto a secondary display so that a user may view the content when the user is not in the line of sight of the primary display in accordance with one or more embodiments of the disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

Described herein are systems and methods for using a primary display and a secondary display to display content for a user device. The primary display may project the content onto the secondary display so that the content may be viewed from a different angle than the primary display. A user may interact or touch the primary or secondary display to interact with the content.

In one implementation, the secondary display may be positioned above or in front of the primary display at an angle that may enable the light emitted or projected from the primary display to be intercepted by the secondary display. In one instance, the images may be projected onto the secondary display so that they may be viewed from the front side of the secondary display that may be facing the user of the user device. In one specific embodiment, the secondary display may be made of a semi-transparent material (e.g., frosted glass) that displays the image on the semi-transparent material. The primary display images may be projected onto the backside of the secondary display, but the images may also be viewed by looking at the front side of the secondary display. In certain instances, the primary display image may be inverted so that the projected image viewed from the front side of the secondary display has the same look and feel (e.g., orientation) of the content that the user would see if viewing the content on the primary display.

In another specific implementation, the secondary display may be made of a transparent material that refracts the light emitted from the primary display so that the user may see the primary display content from a different angle. The secondary display may be placed at an angle above or in front of the primary display. For example, a user may point or position the user device so that the primary display is not readily visible to the user. However, the secondary display may be positioned relative to the primary display to capture the light from the primary display and relative to the user to direct a light to the line of sight of the user.

In one implementation, the secondary display may include a touch sensitive component that may determine where the secondary display has been touched by the user. The touch sensitive component may include a pressure sensitive structure that may be able to determine the discrete locations of where the touch might have been made on the secondary display. For example, the touch sensitive component may have the resolution to differentiate between the locations of several images that are displayed by the secondary display. Accordingly, a user may be able to touch a secondary display image, and the touch sensitive component may send the location or coordinates of the touch to a processor in the user device. The touch sensitive component may be on the front surface or back surface of the secondary display. In another instance, the touch sensitive component may be embedded in the secondary display.

In this implementation, the user device may map the location of the images on the primary display to the locations of the images on the secondary display. The mapping may provide a horizontal and vertical coordinate (e.g., x-y coordinates) mapping of the primary display and the secondary display. For example, the mapping may indicate where the images are located within the primary display and where the corresponding images may be located on the secondary display. The content on the primary display may include a search button, and the mapping may include the location and boundaries of the search button. When the primary display detects a user's touch at the location, the user device may execute a command to display a search prompt. In another instance, the user may elect to interact with the secondary display instead of the primary display. The user may select an image that may be displayed on the secondary display, and the touch sensitive component may determine a location of the touch instance on the secondary display. Accordingly, the touch location or coordinates may be provided to the processor, and the processor may compare the mapping of the secondary display and the primary display to determine which image on the primary display may correspond to the touch location on the secondary display. For example, when the user touches the projected image of a search button on the secondary display, the search button touch location may be sent to the processor. The processor may use the mapping information to determine that the secondary display touch location corresponds to the search image on the primary display. The user device may then execute the search prompt as if the user had selected the search image on the primary display.

In another implementation, the secondary display may include a magnification component attached to one of the surfaces of the secondary display. The magnification component may increase the size of the images on the secondary display. The mapping information between the primary display and the secondary display may be calibrated to account for the image magnification on the secondary display.

### Illustrative System

FIG. 1 illustrates a perspective view of a system 100 that includes a user device 102 that may use a primary display 104 to project an image onto a secondary display 106 to provide another viewing angle for the content. In this way, the user may be able to see and interact with the user device 102 when the primary display 104 is not within the line of sight of the user (not shown). In one embodiment, the primary display 104 and the secondary display 106 may be touch sensitive which enables the user to interact with the user device 102. In this instance, the user may be able to interact with the user device 102 by touching the primary display 104 or the secondary display 106. The user may not have to touch the primary display 104 to direct the user device 102 to execute commands. The secondary display 106 may offer the same or substantially similar functionality that may be provided by interacting with the primary display 104.

The user device 102 may include, but is not limited to, smartphones, mobile phones, tablet computers, handheld scanners, an in-vehicle computer system, and so forth. Although the user device 102 is illustrated as a single device, the components that implement the content collection may be implemented across separate devices or components (not shown) that are electrically coupled to each other by wires or wirelessly. Hence, the system 100 may not need to have the primary display 104 or the secondary display 106 in close proximity as shown in FIG. 1. For example, the secondary display 106 may be a standalone component that may be electrically coupled to the user device 102 but may not be pivotably coupled to the user device 102.

The user device 102 may include one or more computer processors 108, a memory 110, the primary display 104, the secondary display 106, a keyboard 112, a scanner 114, and one or more network and input/output (I/O) interfaces 116.

The computer processors 108 may comprise one or more cores and are configured to access and execute (at least in part) computer-readable instructions stored in the one or more memories 110. The one or more computer processors 108 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The user device 102 may also include a chipset (not shown) for controlling communications between the one or more processors 108 and one or more of the other components of the user device 102. In certain embodiments, the user device 102 may be based on an Intel® architecture or an ARMO architecture, and the processor(s) 108 and chipset may be from a family of Intel® processors and chipsets. The one or more processors 108 may also include one or more application-specific integrated circuits (ASICs) or application-specific standard products (ASSPs) for handling specific data processing functions or tasks.

The network and I/O interfaces 116 may also comprise one or more communication interfaces or network interface devices to provide for the transfer of data between the user device 102 and another device (e.g., network server) via a network (not shown). The communication interfaces may include, but are not limited to: personal area networks (PANs), wired local area networks (LANs), wireless local area networks (WLANs), wireless wide area networks (WWANs), and so forth. The user device 102 may be coupled to the network via a wired or wireless connection. However, the wireless system interfaces may include the hardware and software to broadcast and receive messages either using the Wi-Fi Direct Standard (see Wi-Fi Direct specification published in October 2010) and/or the IEEE 802.11 wireless standard (see IEEE 802.11-2012, published Mar. 29, 2012) or a combination thereof. The wireless system (not shown) may include a transmitter and a receiver or a transceiver (not shown) capable of operating in a broad range of operating frequencies governed by the IEEE 802.11 wireless standards. The communication interfaces may utilize acoustic, radio frequency, optical, or other signals to exchange data between the user device 102 and another device such as an access point, a host computer, a server, a router, a reader device, and the like. The network may include, but is not limited to: the Internet, a private network, a virtual private network, a wireless wide area network, a local area network, a metropolitan area network, a telephone network, and so forth.

The one or more memories 110 comprise one or more computer-readable storage media (CRSM). In some embodiments, the one or more memories 110 may include non-transitory media such as random access memory (RAM), flash RAM, magnetic media, optical media, solid state media, and so forth. The one or more memories 110 may be volatile (in that information is retained while providing power) or non-volatile (in that information is retained without providing power). Additional embodiments may also be provided as a computer program product including a non-transitory machine-readable signal (in compressed or uncompressed form). Examples of machine-readable signals include, but are not limited to, signals carried by the Internet or other networks. For example, the distribution of software via the Internet may include a non-transitory machine-readable signal. Additionally, the memory 110 may store an operating system 118 that includes a plurality of computer-executable instructions that may be implemented by the processor 108 to perform a variety of tasks to operate the interface(s) 116 and any other hardware installed on the user device 102. The memory 110 may also include a location module 120, a content module 122, and a scanning module 124.

The location module 120 may determine the location of images being displayed on the primary display 104 and the secondary display 106. The location of an image may include the region of the display that is covered by or encompassed by the image. For example, a selectable element or button shown on the primary display 104 (e.g., product 126) or the secondary display 106 (e.g., product 128) may include the selectable area of the button. This may include the region that is covered by the perimeter or boundary of the selectable element or button displayed on the primary or secondary display 104, 106. This may mean that the image may be represented by more than one coordinate location on the display. For example, the primary selectable element (e.g., product 126) may cover several coordinate locations within the primary display 104, and the user may touch one or more of the location coordinates with his or her finger or stylus for the location module 120 to register a selection of the primary selectable product 126 button. Likewise, the location module 120 may also map the location of the selectable elements (e.g., product 128) on the secondary display 106.

The location module 120 may also map the location of the images on the primary display 104 to the images on the secondary display 106. In addition to knowing the location coordinates of selectable images on both displays, the location module 120 may map the location coordinates of the images on the secondary display 106 to the corresponding images on the primary display 104. For example, the location coordinates for the selectable element (e.g., product 128) on the secondary display 106 may be tied to the corresponding selectable element (e.g., product 126) on the primary display 104. Hence, when the selectable element (e.g., product 128) is selected on the secondary display 106, the user device 102 may implement or execute a command that is assigned to the selectable element (e.g., product 126) on the primary display 104. In this way, the user may interact with the user device 102 in the same or substantially similar manner using the primary display 104 or the secondary display 106.

The content module 122 may include the content that may be displayed by the primary display 104 and, in turn, displayed on the secondary display 106. The content may include, but is not limited to, computer-readable instructions, library files, and/or images that may be used to provide an interactive experience for the user. In one embodiment, the content may include inventory control or logistics management for goods in commerce. For example, the content may include inventory information related to the type, location, and/or quantity of a variety of goods. The content may also include an interface that may be presented to the user to search the inventory and/or receive or enter information related to the movement or disbursement of the goods. The user device 102 may also include a scanner 114 that may scan images or bar codes associated with the goods. The information may be confirmed by the user as to the type, location, and/or quantity of the goods assigned to the bar code. The content module 122 may store the information that was scanned into the user device 102. Also, the content module 122 may request additional information (e.g., order information) over a network (not shown) that may be presented on the primary display 104. The content module 122 may also include user interface icons that may be presented on the primary display 104. In general, the content module 122 may be used to store any information, data, or electronic file that may be used to display an image, feature, or element on the primary display 104 of the user device 102.

The scanning module 124 may include, but is not limited to, controlling and/or operating the scanner 114 that will be described in greater detail below. Briefly, the scanner 114 may send and receive light to obtain or exchange information with nearby images or objects. The scanning module 124 may control the light emission techniques or timing to emit a light signal that may be reflected off of the images or objects. The reflected light may be encoded with information based, at least in part, on how the images or objects alter the light during the reflection process. The scanning module 124 may include computer-executable instructions that may be used to decode the reflected light signals to extract the information or content encoded in the reflected light. For example, the scanner 114 may emit light towards a bar code or other image that may alter or encode the light emitted during the reflection process. The emitted light may also be encoded when reflected off of objects or geometrical shapes. The scanning module 124 may control the light emission and receiving process to obtain a clear reading of the information encoded within the reflected light. In one specific embodiment, the scanning module 124 may be able to, but is not limited to, decoding information from light reflected by 1D, 2D, and/or 3D Universal Product Codes.

In another embodiment, the scanner 114 may include an image capture device or a data acquisition device that may capture images of objects or data/information embedded in objects. The scanning module 124 may analyze the images to extract information related to the object. For example, the analysis may determine the type or model of the object so that object may be identified and information about the object may be collected and displayed to the user. In another instance, the analysis may include decoding information in the image. For example, the image may include a bar code, words, letters and/or other identifiers that may be used to identify the object or that may represent information related to the object captured in the image.

The primary display 104 may be a light-emitting display for the user device 102 that displays content or information that may be viewed by a user (not shown). The primary display 104 may include, but is not limited to, a liquid crystal display, a light-emitting diode display, an organic light-emitting diode display, a thin film transistor display, a resistive touch screen display, a capacitive touch screen display, a haptic display, or a plasma display. The primary display 104 may or may not be touch enabled. In one specific embodiment, the primary display 104 may be a capacitive touch screen display that displays content and may detect touch instances from the user. The touch instances may be in the location of selectable elements that are displayed on the primary display 104. The user device 102 may respond to the touch instances by executing any commands that are assigned to the selectable elements. The user device 102 may also include a mechanical interface (e.g., keyboard 112) that may be used to move a cursor to the selectable elements and to select the selectable elements to execute the assigned command.

The secondary display 106 may include a relatively flat piece of transparent or semi-transparent material that may be formed into a substantially square or rectangular geometry. The secondary display 106 may include a front surface and a back surface and may be pivotably coupled to the user device 102 near the base of the primary display 104. The angle of the secondary display 106 with respect to the primary display 104 may be adjusted using the pivotable coupling. In one embodiment, the angle between the primary display 104 and the secondary display 106 may not be more than about eighty nine degrees. In one specific embodiment, the angle may be about thirty degrees. The angle may place the secondary display in a variety of positions in which the light emitted from the primary display 104 may be intercepted by the secondary display 106. The light may be reflected or refracted by the secondary display 106.

In one embodiment, the secondary display 106 may include two or more relatively flat surfaces that provide a projection or refraction surface for the primary display 104. In one instance, the light from the primary display 104 may be projected on the semi-transparent material or component of the secondary display 106 in a way that the images on the primary display 104 may be visible on the front and/or back surfaces of the secondary display 106. The front and back surface images of the secondary display 106 may be oriented in a similar manner as the primary display 104 images. However, in another instance, the front surface image may be oriented in a similar manner as the primary display 104, but the back surface image of the secondary display 106 may be inverted. In this instance, the primary display 104 may invert its image so that the back surface image of the secondary display 106 may be oriented in way that would normally be viewed on the primary display 104, if the secondary display 106 was not being used.

In another instance, the light from the primary display 104 may be refracted by the transparent material or component of the secondary display 106. The refracted image may be visible to the user (not shown) when the user is in the line of sight of the secondary display 106. The line of sight may be adjusted by changing the angle or position of the secondary display 106 with respect to the primary display 104 or by the user positioning his or her eyes within the line of sight of the light that is refracted by the secondary display 106.

In the above embodiments, the secondary display 106 may also include a touch sensitive component that covers most of the flat surface of the secondary display 106. The touch sensitive component may detect touch instances by the user on the secondary display 106. This feature may be used to interact with or to select the images on the secondary display 106. The touch sensitive component may be on the front or back surface or embedded within the material of the secondary display 106. In one specific embodiment, the touch sensitive component may include, but is not limited to, an infrared resistive touch screen, capacitive touch, Interpolating Force-Sensitive Resistance (“IFSR”), touch, etc.

The touch sensitive component (not shown) may include an array of location dependent sensors. When pressure is applied to a location on the secondary display 106, the affected location sensors may provide location information of the touch instance to the location module 120 via wires between the secondary display 106 and the user device 102. The location information may include, but is not limited to, coordinate information that indicates the position of the touch instance. For example, this may include x-y coordinates of the touch instance. In another instance, the touch instance may involve more than one location dependent sensor. In this case, the location information may include the coordinates from each of the location sensors.

In another embodiment, the location information may also be reported gestures made by the user. For example, these gestures may include double taps by a single finger, a drag gesture by one or more fingers, and/or a zoom-in/zoom-out gesture made by moving two fingers apart or together. The location information for the gestures may be interpreted by the location module 120 to implement the gesture commands described above. The gesture commands that may be interpreted by the location module 120 are not limited to the gestures described above and may include any touch gesture implemented by one or more fingers of the user.

The user device 102 may also include a keyboard 112 which may include, but is not limited to, letter, number, or command buttons that enable a user to enter information, execute commands, and/or move a cursor around on the primary display 104. In one specific embodiment, the keyboard 112 may include a QWERTY style keyboard. In another embodiment, the keyboard 112 may include a telephone keypad where each key may be assigned one number and two or more letters.

The scanner 114 may include, but is not limited to, a light-emitting device (not shown) and/or a light sensing device (not shown). In one embodiment, the scanner 114 may be able to emit light using a photodiode or other light source. The emitted light may be reflected off of images and/or objects that are in the line of sight of the light-emitting device of the scanner 114. The reflected light may be received by the scanner 114 using a light sensitive diode that converts the light to an electrical signal. The reflected light may be encoded within information that may be decoded by the user device 102.

FIG. 2 illustrates a system 200 that is the same or similar to system 100 using a top view 202, a side view 204, and a front view 206. The system 200 may include the primary display 104 to project an image onto a secondary display 106 to provide another viewing angle for the content displayed on the primary display 104.

In the top view 202, the user device 102 may include a primary display 104 that is below the secondary display 106 that may include a projection of the content being displayed on the primary display 104. In this embodiment, the projected content may include selectable elements (e.g., product 128, location 208, quantity 210, order #212) that are also shown on the primary display 104. The product 126 button is the only selectable element visible in the top view 202. However; additional icons that correspond to the selectable elements are shown on the secondary display 106. The scanner 114 and the keyboard 112 are also shown in the top view 202.

In the side view 204, the secondary display 106 may be pivotably coupled to the user device 102 at the pivot point 214 that enables the angle between the primary display 104 (not shown) and the secondary display 106 to be adjusted. This angular movement may be illustrated by the double-ended arrows to the left of the pivot point 214 indicating how the angle may be adjusted. The angle may be adjusted to account for the viewing preference of the user that may be viewing the secondary display 106 from the front of the user device 102.

The light 216 emitted from the primary display may be projected onto the secondary display 106. The user 218 may touch the secondary display 106 to initiate the selection of the selectable elements (e.g., product 128, location 208, quantity 210, order #212) or to make a gesture that may initiate a command by the user device 102. As discussed in the description of FIG. 1, the location of the touch instance or gesture may be provided to the location module 120 to indicate which selectable element (e.g., product 128) was selected. In this instance, the location module 120 may determine that the product 126 button on the primary display 104 corresponds to the touch instance. Hence, the user device 102 may display a prompt for a product number that may be entered by the keyboard 112 or may be scanned in by using the scanner 114.

In the front view 206, the user device 102 is shown as if the scanner 114 (not shown in front view 206) may be pointed at a bar code image, and the user may view the secondary display 106 that may include the selectable elements (e.g., product 128, location 208, quantity 210, order #212).

FIG. 3 illustrates an exemplary embodiment 300 of mapping the location of images on the primary display 104 to the location on the secondary display 106. The embodiment 300 illustrates a front view 302 of the user device 102 with the secondary display 106 in an angled position and a top view 304 of the user device 102 showing the primary display 104. The secondary display 106 is not shown in the top view 304 and may be considered removed from the user device 102 for the purpose of describing FIG. 3.

In this embodiment, the primary display 104 may include four selectable elements (e.g., product 126, location 306, quantity 308, order #310) that may be selected by touching at least a portion of the element within the region referenced by the line that surrounds the displayed word of each element. The location module 120 may assign those regions of the primary display 104 screen to different commands that may be executed by the user device 102 when those regions are touched by the user.

The front view 302 may include the secondary display 106 that may include the projected image of the primary display 104. The projected image may include selectable elements (e.g., product 128, location 208, quantity 210, order #212) that may be touched by a user. The location module 120 may determine the location of the regions covered by the selectable elements or buttons (e.g., product 128, location 208, quantity 210, order #212). The location module 120 may map 312 the location of the product 128 button to the product 126 button. In this way, when the product 128 button is selected, the location module 120 may execute the command assigned to the product 126 button. In the alternative, the location module 120 may map the command associated with the product 126 button rather than map the secondary product 128 button to the region of the primary display 104 covered by the product 126 button. Similarly, the location module 120 may map 314 the location of the location 208 button to the location 306 button. Additionally, the location module 120 may also map 316, 318 the quantity 210 button and the order #212 button to their corresponding buttons or regions 308, 310 on the primary display 104. Hence, when one of the selectable elements (e.g., product 128, location 208, quantity 210, order #212) on the secondary display 106 are selected, the location module 120 may determine the corresponding button or region, via the mapping, and may execute a command that is assigned to the corresponding button or region.

FIG. 4 illustrates another embodiment of a system 400 that segregates a primary display 402 from a secondary display 404 as shown in a side view 406 and a front view 408. In certain instances, access to a network or a computing device may have to be controlled for environmental reasons. For example, placing water and dirt sensitive computer equipment outside may cause computer failure or reliability problems. However, placing the sensitive computer equipment in a safe environment may limit access or capability to a user that may need to use the equipment while the user is outside. However, by offering a secondary display 404 that may be more capable of dealing with the outside environment, a user may be able to fully utilize or interact with the user device 410 as if the user was using the primary display 402. The user device 410, the primary display 402, and the secondary display 404 may include the same or similar capabilities of the user device 102, the primary display 104, and the secondary display 106 as discussed above in the description of FIGS. 1-3.

In one embodiment, the system 400 may include a wall 412 or a barrier that segregates the primary display 402 and the user device 410 environment on the front surface 414 of the wall 412. The controlled environment may begin on the back surface 416 of the wall 412 and may envelop the primary display 402 and the user device 410. In this embodiment, the wall 412 may include a hole 418 that enables the primary display 402 to emit light that may be projected onto the secondary display 404. This may enable the content displayed on the primary display 402 to be displayed on the secondary display 404. The user 420 may use his or her hand or stylus to select images or make gestures on the secondary display 404. The location of the touch instances may be provided to the user device 410 using wires (not shown) that are run from the secondary display 404.

The front view 408 of the system 400 shows the secondary display 404, the wall 412, and the selectable elements (e.g., part number 422, billing number 424, search 426) that are projected onto the secondary display 404 from the primary display 402 (not shown in the front view 408). The selectable elements (e.g., part number 422, billing number 424, search 426) may have corresponding features (not shown) that are displayed on the primary display 402 (not shown in the front view 408). When the user 420 selects one or more of the selectable elements (e.g., part number 422, billing number 424, search 426), the user device 410 may review the mapping information between the primary display 402 and the secondary display 404 to determine which commands are assigned to the corresponding elements on the primary display and then execute the commands based, at least in part, on the selection of the selectable elements (e.g., part number 422, billing number 424, search 426).

FIG. 5 illustrates a flow diagram 500 of a method for projecting content from a primary display 104 onto a secondary display 106 so that a user may view the content when the user is not in the line of sight of the primary display 104. As noted above in FIGS. 1-3, the secondary display 106 may be positioned above the primary display 104 to intercept light emitted by the primary display 104. The secondary display 106 may be made of a transparent or semi-transparent material that reflects or directs the content to the line of sight of the user. The secondary display 106 may also include a touch sensitive component that may detect user touch instances on the secondary display 106. Accordingly, the user may view and interact with the displayed content on the secondary display 106 in the same or similar manner when using the primary display 104.

At block 502, the primary display 104 may display content stored in a user device 102. In one embodiment, the content may include selectable elements (e.g., icons, text links) that can execute one or more commands on the user device 102. The user device 102 may be a mobile device that may be used in several orientations in which the primary display 104 may not be within the line of sight of the user. For example, the user device 102 may be used to complete a task that places the primary display 104 out of the user's line of sight. The user device 102 may include a scanner 114 that may be pointed at an object, and the user cannot see the display to determine if the scanning was properly completed.

In one embodiment, at least a portion of the secondary display 106 may be positioned above or in front of the primary display 104 to intercept the light emitted from the primary display and be in the line of sight of the user. Hence, the user may be able to determine whether the scanning was properly completed without having to reposition the user device 102 to place the primary display 104 in the user's line of sight.

At block 504, the secondary display 106 may display a refracted image of at least a portion of the content that may be displayed on the primary display 104. The emitted light from the primary display 104 may be encoded with the content image. The secondary display 106 may refract that light in a way that directs the emitted light to the line of sight of a user. The material of the secondary display 106 may include a glass, plastic, or other substantially transparent material that may refract light. The refraction changes the direction of the light by changing the phase velocity of the light, and the frequency of the light may remain substantially constant. In other words, refraction may be the bending of light when the light passes through a boundary between two different media (e.g., air, glass). Refraction may be explained by Snell's law that quantifies the amount of refraction based on the light's angle of incidence with the media and the media's index of refraction that may be a dimensionless value that characterizes how light may be impacted by the media.

In this embodiment, the content of the primary display 104 may appear to be displayed on the secondary display 106. The user may be able to interact with the content displayed on the secondary display 106 by using his or her finger or stylus. The secondary display 106 may include a touch sensitive component on the surface or embedded in the secondary display 106. The touch sensitive component may include several sensors throughout the secondary display 106 that may be able to detect touch instances made on the secondary display 106.

At block 506, the touch sensitive component may determine a contact location of a touch contact made on the secondary display 106 by the user using his or her finger or stylus. The touch sensitive component may generate a signal encoded with the location of the touch instance on the secondary display 106.

In one embodiment, the touch sensitive component may include several pressure or light sensors spread throughout the secondary display 106. The sensors may generate signals that are encoded with their relative position in the secondary display 106. In one specific instance, the encoded information may include x-y coordinates.

At block 508, the secondary display 106 may provide the contact location to the processor 108 or memory 110 of the user device 102. The secondary display 106 may be electrically coupled to the user device 102 using wires that couple the touch sensitive component to an electrical connection on the user device 102.

At block 510, the user device 102 may determine that a selectable element (e.g., icon, link) on the primary display 104 corresponds to the contact location on the secondary display 106. The user device 102 may map the locations of the selectable elements on the primary display 104 to the location sensors on the secondary display 106. In this way, the mapping may enable the user device 102 to determine a correspondence between the selectable elements on the primary display 104 and the touch locations made on the secondary display 106. This concept is discussed above in the description of FIG. 3.

At block 512, the user device 102 may execute at least one command that is assigned to the selectable element when the selectable element on the primary display 104 may be determined to correspond to the contact location on the secondary display 106. For example, the selected element may be an icon that initiates the scanner 114 to collect information from an image that is located on a wall or a package. The scanner 114 may read the image, and the user device 102 may display the result of the scan on the primary display 104. The secondary display 106 may also display the information to place the information in the line of sight of the user. The user may accept or confirm the information by touching the secondary display 106.

In another embodiment, the secondary display 106 may be placed in another position that may be substantially flush with the primary display 104. The secondary display 106 may display a refracted image of the content being displayed on the primary display 104. The user device 102 may map the selectable elements on the primary display 104 with the location sensors on the secondary display 106. Accordingly, when a touch instance is detected by the secondary display 106, the user device 102 may determine which selectable element on the primary display 104 corresponds to the touch instance. The user device 102 may execute a command that is assigned to the selectable element that corresponds to the touch instance.

FIG. 6 illustrates a flow diagram 600 of another method for projecting content from a primary display 104 onto a secondary display 106 so that a user may view the content when the user is not in the line of sight of the primary display 104. In one embodiment, the secondary display 106 may include a semi-transparent material that may enable the images on the primary display 104 to be projected onto the semi-transparent surface. The content images may be visible on the front surface of the secondary display 106 that faces the primary display 104, as well as the back surface of the secondary display 106 that may be in the user's line of sight. In another embodiment, the projection of the content on the secondary display 106 may be inverted from side to side so that the content is displayed by the primary display 104. In this instance, the user device 102 may invert the content on the primary display 104 so that the image on the secondary display 106 may be oriented in a way that the user would expect to see on the primary display 104.

At block 602, the primary display 104 may project light encoded with one or more images. At least one of the images may be assigned a command that is executed when the at least one image is selected by a user. The image may be selected by a finger or stylus of the user by touching the primary display 104. Alternatively, the user may use a keyboard or other mechanical interface device to select the image with a cursor.

In one embodiment, the user device 102 may determine the secondary display 106 is in a position to receive or intercept the light emitted from the primary display 104. The user device 102 may invert the content on the primary display 104 when the position determination is made.

The user device 102 may also map locations of the one or more images on the primary display 104 to locations of at least a portion of the one or more images that may be projected on the secondary display 106. The mapping may be based on the size of the secondary display 106, the location of the touch sensors within the secondary display 106, or the angle and distance between the primary display 104 and the secondary display 106. The mapping information may determine a relationship between the location of a touch instance on the secondary display 106 and the location of a selectable element on the primary display 104.

At block 604, the secondary display 106 may display the one or more images that were encoded in the light projected from the primary display 104. The selectable elements on the primary display 104 may be visible on the secondary display 106. Hence, the user may be able to view the images and information as they would appear on the primary display 104, or the images may be inverted as they would appear on the primary display 104.

At block 606, the user device 102 may determine a location of a touch instance on the secondary display 106. As described above in the description of FIG. 1, the secondary display 106 may include touch sensitive components throughout the secondary display 106 that may send a signal to the user device 102 when the components are pressed and an object blocks the light from reaching the component. The touch sensitive component may be a touch sensitive film on the surface of the secondary display 106 or embedded in the secondary display 106. The touch instance may include a single touch that is stationary, a double touch at the same location, or a gesture touch that changes the location on the secondary display 106 before being disengaged from the secondary display 106.

At block 608, the user device 102 may determine the location of the touch instance that corresponds to the at least one image displayed on the primary display 104. The user device 102 may use the mapping information that correlated the touch locations on the secondary display 106 to the selectable elements on the primary display 104.

At block 610, the user device 102 may implement the command assigned to the at least one image when the location of the touch instance corresponds to the at least one image. In this way, the user may be able to interact with the user device 102 using the secondary display 106 in the same or similar manner as with the primary display 104.

### CONCLUSION

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to flow diagrams of systems, methods, apparatuses, and/or computer program products according to various implementations. It will be understood that one or more flow diagrams can be implemented by computer-executable program instructions. Likewise, some flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, flow diagrams support combinations of means for performing the specified functions, combinations of elements or steps for performing the specified functions and program instruction means for performing the specified functions. It will also be understood that each block of the block diagrams and flow diagrams, and combinations flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A method, comprising:
displaying content on a primary display of a user device, the content comprising selectable elements that enable execution one or more commands on the user device;
refracting light emitted from the primary display using a secondary display, the light being encoded with at least a portion of the content being displayed on the primary display;
determining a contact location of a touch contact made on the secondary display;
determining a selectable element on the primary display that corresponds to the contact location on the secondary display; and
executing at least one command on the user device that is associated with the selectable element when the selectable element on the primary display is determined to correspond to the contact location on the secondary display.

2. The method of claim 1, further comprising:
positioning the secondary display at an angle in front of the primary display; and
capturing, via the user device, an image to collect information about an object, a location of the object, or a status of the object, the information being displayed on the primary display.

3. The method of claim 2, wherein the angle comprises no more than eighty nine degrees between a surface of the secondary display and a surface of the primary display.

4. The method of claim 1, wherein secondary display comprises a semi-transparent or transparent material.

5. The method of claim 1, further comprising:
displaying a result of the at least one command on the primary display; and
refracting an image on the secondary display, the other image comprising the result of the at least one command.

6. The method of claim 1, further comprising:
positioning the secondary display to be substantially parallel with the primary display;
refracting an image of the content on the secondary display;
determining a second contact location of a second touch contact made on the secondary display;
determining a second selectable element on the primary display that corresponds to the second contact location on the secondary display; and
executing at least a second command on the user device that is assigned to the second selectable element based, at least in part, on determining the correspondence between the second contact location on the secondary display and the second selectable element on the primary display.

7. The method of claim 1, wherein the secondary display comprises a refractive material that allows light to pass from one surface of the refractive material and out from a second surface of the refractive material.

8. A system, comprising:
a memory that stores computer-executable instructions;
a display device that displays content by emitting light; and
a transparent component that is positioned to intercept at least a portion of the light emitted from the display device and to project at least a portion of the content, the transparent component comprising a touch sensitive component that detects touches to at least a portion of the transparent component.

9. The system of claim 8, further comprising an image capture device to receive the light that is encoded with information, wherein the display device displays at least a portion of the information and the transparent component projects the portion of the information by intercepting additional light emitted from the display device.

10. The system of claim 8, further comprising a processor to:
receive coordinate information from the transparent component, the coordinate information indicating a location of a touch instance on the transparent component; and
determine a location on the display device that corresponds to the location of the touch instance on the transparent component, the location on the display device comprising a selectable element that is assigned to an executable command; and
implement the executable command when the location of the touch instance corresponds to the location of the selectable element.

11. The system of claim 8, wherein the transparent component comprises a bottom portion that is pivotably coupled near a bottom portion of the display device.

12. The system of claim 8, wherein the transparent component receives the light on a first surface and emits the light via a second surface, the first surface and the second surface being substantially parallel to each other.

13. The system of claim 12, wherein the touch component is located on the first surface or the second surface, or in between the first surface and the second surface.

14. The system of claim 8, further comprising a magnification lens coupled to a surface of the transparent component.

15. One or more computer-readable media storing computer-executable instructions that, when executed by at least one processor, configure the at least one processor to perform operations comprising:
emitting light encoded with one or more images from a display for a user device, and at least one of the images is assigned a command that is executed when the at least one image is selected;
receiving the light encoded with the one or more images at a substantially transparent display comprising a touch sensitive component;
projecting at least a portion of the one or more images from the substantially transparent display;
determining, using the touch sensitive component, a location of a touch instance on the substantially transparent display;
determining the location of the touch instance corresponds to the at least one image displayed on the display; and
implementing the command assigned to the at least one image when the location of the touch instance corresponds to the at least one image.

16. The computer-readable media of claim 15, the computer-executable instructions further comprising:
determining the substantially transparent display is in a position to receive the light; and
inverting the one or more images on the display.

17. The computer-readable media of claim 15, the computer-executable instructions further comprising mapping locations of the one or more images on the display to locations of at least a portion of the one or more images on the substantially transparent display.

18. The computer-readable media of claim 17, wherein the mapping comprises vertical and horizontal coordinates of the one or more images on the display and vertical and horizontal coordinates of the one or more images on the substantially transparent display.

19. The computer-readable media of claim 15, wherein the substantially transparent display refracts the light received from the display.

20. The computer-readable media of claim 15, wherein the touch sensitive component comprises a touch sensitive film on a surface of the substantially transparent display or embedded in the substantially transparent display.
